(19) United States
(12) Patent Application Publication
(10) Pub. No.: US 2026/0058859 A1
(43) Pub. Date: Feb. 26, 2026

(54) Techniques for Improving the Security, Reliability, and Performance of Monitoring Systems

(71) Applicant: CDW LLC, Vernon Hills, IL (US)

(72) Inventors: Frederick Holston, Prescott, AZ (US); Joshua Peacock, Harrisburg, SD (US); Cory Smith, Salt Lake City, UT (US)

(21) Appl. No.: 18/810,467

(22) Filed: Aug. 20, 2024

(51) Int. Cl. H04L 41/0604; H04L 41/16; H04L 67/12

(52) U.S. Cl. CPC H04L 41/0627; H04L 41/16; H04L 67/12

(57) ABSTRACT

Techniques for improving data reliability, security, and monitoring performance are disclosed herein. An example device includes a networking interface providing access to (i) a centralized record including entity data and (ii) sensors configured to sense phenomena associated with the entity; processors; and memories communicatively coupled with the networking interface. The sensors and processors store (i) a local record of cached data and (ii) computer-executable instructions thereon that, when executed, cause the device to: receive a set of measurements of the one or more phenomena sensed by the one or more sensors, determine an event corresponding to the entity based on the set of measurements, update the centralized record with event data associated with the event, and cache at least a portion of the event data in the local record.

### TECHNICAL FIELD

The present disclosure generally relates to monitoring systems, and more particularly, to techniques for improving the security, reliability, and performance of monitoring systems a centralized record with event data and caches a portion of the event data in the local record.

### BACKGROUND

Generally, data reliability and security is important to many industries and fields. For example, it is important to the healthcare industry to keep an accurate, reliable, and secure record of events that affect patient well-being and treatment.

However, conventional techniques for data suffer from notable drawbacks. Namely, conventional techniques generally lack an integrated solution that ensures both reliability and security. As an example, in the healthcare industry, if there is a power outage affecting the central storage location (e.g., host server(s)) for electronic health records, such records can be inadvertently deleted, corrupted, or otherwise adjusted inaccurately when the storage location suddenly disconnects from healthcare provider devices. Further, when such centrally stored records are accessed by malicious actors or otherwise compromised, the host may be forced to deny access to all parties until such security threats are alleviated, leaving healthcare providers without a reliable, secure data storage location for vital patient records. In either event, these conventional techniques unacceptably force users to accept convenience at the expense of data reliability/security.

Another drawback in conventional techniques is that as more devices are added, more infrastructure is required, such as physical building of network connectivity. Expanding infrastructure can be costly and prohibitive for many organizations, which reduces access to newer and more advanced technologies. For example, in a healthcare setting, this can reduce patient outcomes and quality of care.

In addition, conventional techniques suffer from an inability to synthesize data from a variety of disparate sensors. Continuing the healthcare example, in a typical patient room, there can be many sensors recording data, but they are normally connected to separate systems and act as simple data acquisition machines. This can make reviewing patient data cumbersome and inefficient for healthcare professionals and lead to a general lack of consensus when developing diagnoses, treatment plans, etc.

Therefore, in general, accurate, secure, and reliable data monitoring and storage is an area of great interest, and conventional techniques can be insufficient for providing such data monitoring or storage. Accordingly, a need exists for techniques that provide users with accurate, secure, and reliable data monitoring and storage and thereby mitigate the negative effects stemming from ineffective conventional techniques.

### SUMMARY

In some aspects, a device for improving data reliability comprises a networking interface providing access to (i) a centralized record including data corresponding to an entity and (ii) one or more sensors configured to sense one or more phenomena associated with the entity, one or more processors; and one or more memories communicatively coupled with the networking interface, the one or more sensors, and the one or more processors. These memories are capable of storing (i) a local record of cached data and (ii) computer-executable instructions thereon that, when executed by the one or more processors, cause the device to receive, via the networking interface, a set of measurements of the one or more phenomena sensed by the one or more sensors, determine an event corresponding to the entity based on the set of measurements, update the centralized record with event data associated with the event, and cache at least a portion of the event data in the local record.

In some aspects, a method for improving data reliability comprises accessing, by one or more processors, a (i) a centralized record including data corresponding to an entity and (ii) one or more sensors configured to sense one or more phenomena associated with the entity, and storing (i) a local record of cached data and (ii) computer-executable instructions thereon that, when executed by the one or more processors, to cause a device to receive a set of measurements of the one or more phenomena sensed by the one or more sensors, determine an event corresponding to the entity based on the set of measurements, update the centralized record with event data associated with the event, and cache at least a portion of the event data in the local record.

In some aspects, one or more non-transitory computer-readable storage media include instructions that, when executed by one or more processors, cause the one or more processors to: using a networking interface, providing access to (i) a centralized record including data corresponding to an entity and (ii) one or more sensors configured to sense one or more phenomena associated with the entity, and storing, in one or more memories, (i) a local record of cached data and (ii) computer-executable instructions. These instructions, when executed by the one or more processors, cause a device to: receive a set of measurements of the one or more phenomena sensed by the one or more sensors, determine an event corresponding to the entity based on the set of measurements, update the centralized record with event data associated with the event, and cache at least a portion of the event data in the local record.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts an example computing system in which various embodiments of the present disclosure may be implemented.

FIGS. 2A-B depict high level example computing systems in which various embodiments of the present disclosure may be implemented.

FIG. 3 depicts an example computing system depicting various sensor and hardware components that may be implemented.

FIG. 4 depicts an example computing system depicting how various blocks or engines may be integrated with sensors.

FIGS. 5A-E depict example workflows for the different operational engines that may be implemented, in accordance with various embodiments described herein.

FIG. 6 depicts an example computer-implemented method that may be implemented, in accordance with various embodiments described herein.

### DETAILED DESCRIPTION

Broadly speaking, the systems and methods of the present disclosure improve data accuracy and reliability. More specifically, the techniques of the present disclosure improve data reliability by providing record redundancy in the event of centralized record loss. The techniques of the present disclosure determine if an event occurred, update a centralized record with the event data, and cache a portion of the event data in a local record. As a result, the techniques of the present disclosure overcome the data redundancy issues experienced by conventional techniques.

Namely, conventional techniques often lack data redundancy, particularly distributed redundancy, and thereby suffer from significant data unreliability. In the event of a power outage or network failure, access to critical records can be lost and/or records may be improperly updated. In a healthcare context, this can result in non-optimal outcomes for patients because accurate and reliable data is crucial to achieve proper medical care, such that losing any part of the data is undesirable. Consequently, conventional systems offer little data reliability, redundancy, and synthesis capabilities.

By contrast, the techniques of the present disclosure overcome these data reliability challenges by (1) updating a centralized record with event data and (2) caching at least a portion of the event data in a local record. In this manner, the techniques of the present disclosure ensure that at least a portion of the collected measurements are cached locally to avoid complete data/record loss in the event of a service interruption/failure of the centralized record. These elements therefore enhance the data reliability of the underlying data collection/aggregation systems described herein through increased data redundancy and improve over conventional techniques by distributing the redundant data in a local cache that substantially reduces the likelihood of complete data/record loss, corruption, etc.

Further, in a healthcare context, such local caching allows healthcare providers to more reliably access critical patient data and thereby provide more consistent, high-quality treatment. The present techniques therefore increase overall healthcare provider awareness and corresponding patient outcomes by ensuring that healthcare providers have access to relevant, up-to-date patient data regardless of the accessibility (e.g., offline, disconnected, corrupted) of the centralized record. Overall, the techniques of the present disclosure increase the reliability, accessibility, and completeness of a patient's medical record, resulting in significantly improved patient care.

The techniques of the present disclosure thus improve the functionality of computing devices (e.g., a hosting server and a computing device) at least by storing/caching data in a particular way to enhance the data reliability provided by the computing devices. The techniques of the present disclosure, executing on a computing device, update a centralized record with data and cache at least a portion of that data in a local record in a manner that was not previously performed as part of conventional techniques. That is, the present disclosure describes improvements in the functioning of the computer itself because the computing devices more reliably store data as a direct result of the techniques described herein. This improves over the prior art at least because existing systems typically lack such data redundancy and/or are otherwise unable to store/cache data in the manner(s) described herein.

Still further, the present disclosure includes specific features other than what is well-understood, routine, conventional activity in the field, or adding unconventional steps that demonstrate, in various embodiments, particular useful applications, e.g., receiving, from one or more sensors that are configured to sense one or more phenomena associated with an entity, a set of measurements of the one or more phenomena, determining an event corresponding to the entity based on the set of measurements, updating a centralized record with the event data associated with the event, and caching at least a portion of the event data in the local record.

In some embodiments, a situational awareness engine analyzes data corresponding to the entity that is stored in the centralized record to determine threshold values related to measurements sensed by the sensors. This provides an increased level of data analysis and patient security over conventional techniques by allowing medical practitioners to only be alerted when specific thresholds have been crossed, thereby allowing the practitioners to focus their efforts where they are needed most.

In some embodiments, a treatment awareness engine uses the measurement data to determine treatments that are based on the determined event. This engine can also determine if further notifications need to be made to relevant personnel (e.g., medical staff), and may generate the notifications. This engine therefore allows for more accurate and efficient patient treatment planning as the treatments determined by the engine are based on highly granular measurement data received directly from patient sensors. As a result, this treatment awareness engine leads to significantly improved patient outcomes at least by minimizing the time required for practitioners to develop and implement relevant patient treatment plans/regimens.

Moreover, documenting healthcare activities can generally pose a challenge for practitioners as conventional documentation techniques occupy a significant amount of time that could otherwise be spent treating patients. Accurate and up-to-date healthcare documentation is nonetheless essential to ensure that all providers are unified regarding optimal patient care and treatment. The present techniques alleviate these issues experienced by conventional techniques through the automatic documentation engine which can automate such documentation tasks when a practitioner initiates a medical procedure, check-in, or other activity that requires documentation. The automated documentation engine can be integrated as part of the systems described herein to automatically document events that occur and information associated with the events, such as measurement data from measurements sensed/collected by sensors associated with a patient. The engine intelligently curates which documents should be created in response to each event, as well as manages the data included in each document in response to an event. Accordingly, the automated documentation engine improves over conventional techniques at least by automatically determining and populating relevant documents with sensed/measured data in response to detected events, which minimizes the time practitioners spend documenting events, as opposed to treating them and improving patient outcomes.

In another embodiment, a record continuity engine can be integrated into the system to determine the event data to be stored in the centralized record and the portion of the event data to be cached in the local record, based on one or more of the measurements made by the sensors. The record continuity engine can then update the centralized record with the event data associated with the event and cache at least a portion of the event data in the local record. In this manner, the record continuity engine further improves the data reliability of the present techniques over conventional techniques.

Namely, the record continuity engine accurately determines which data may be critical/crucial for medical practitioners to have on-hand in the event of a medical emergency or other short-term event/scenario and may cache such data in the local record. For example, if a patient experiences cardiac arrest while in the hospital, the medical team overseeing the patient may require immediate access to the patient's most recent heart rate, blood pressure, and/or other cardiac data if the patient experiences another cardiac event, and such data may be unobtainable if the centralized record is temporarily inaccessible (e.g., network issues, corruption, etc.). To avoid such high-risk scenarios, the record continuity engine may determine that the patient's most recent heart rate, blood pressure, and/or other cardiac data should be cached in the local record to ensure that practitioners can readily access such data in the event that the patient experiences subsequent cardiac issues. Accordingly, the record continuity engine improves over conventional techniques at least by intelligently caching data that improves medical practitioner's data access and correspondingly improves patient outcomes through more well-informed planning and treatment.

It should be noted that any or all of the engines described herein can be integrated together into a single system to provide services as needed by the user.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the healthcare context, the techniques described herein may be readily applied in any suitable field for any suitable purpose.

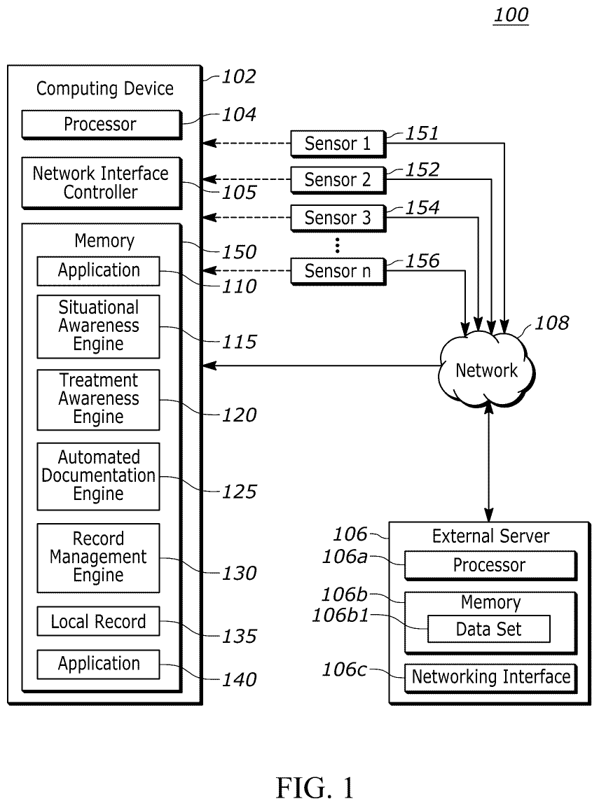

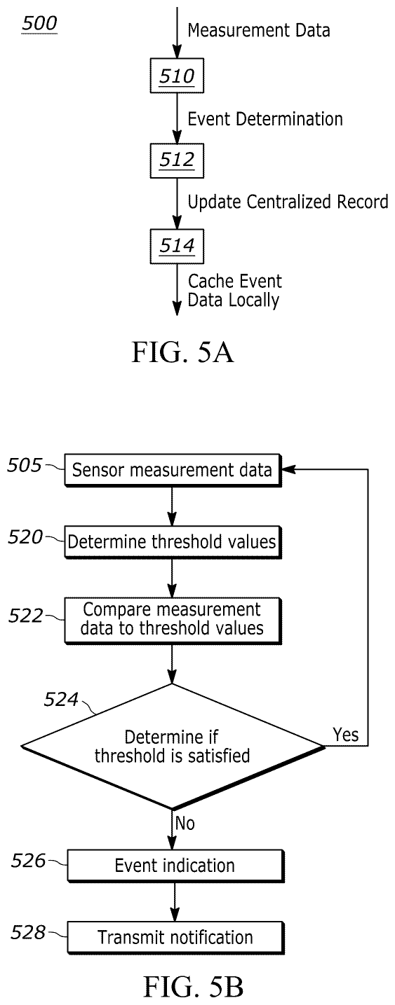

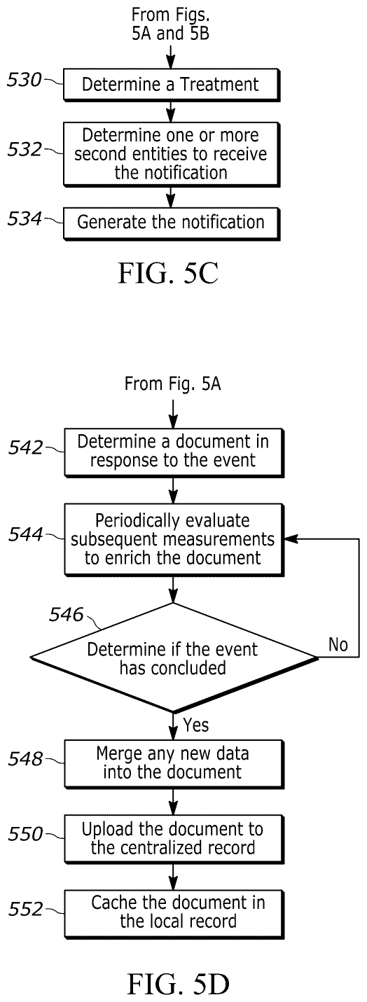

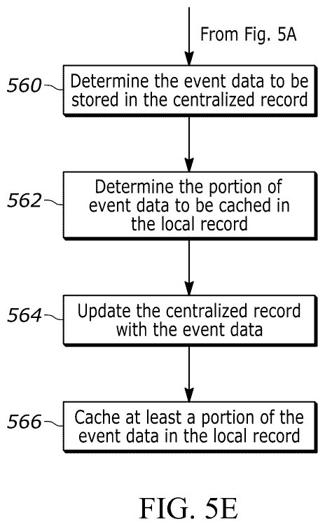

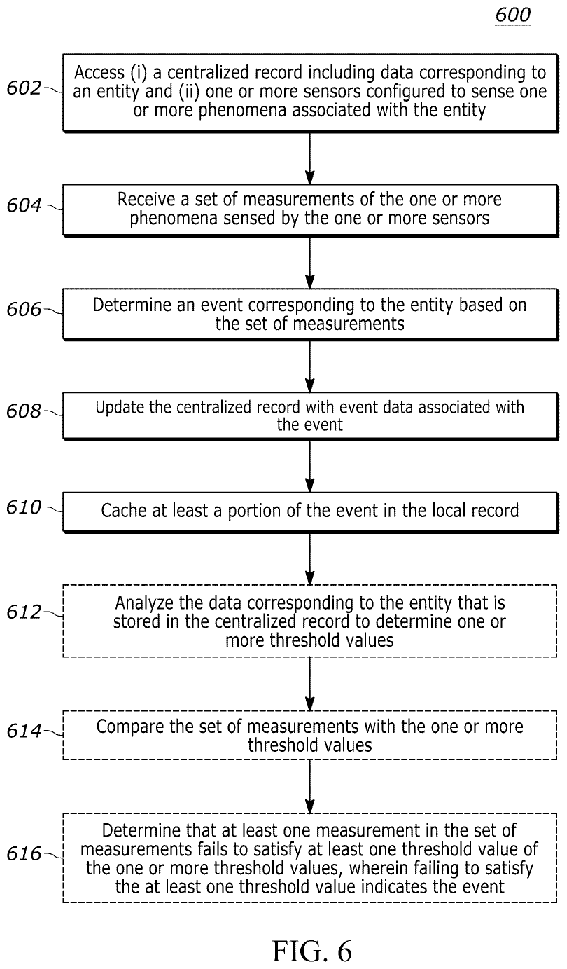

To provide a better understanding of the techniques described herein, FIGS. 1-4 depict various example computing environments in which techniques of the present disclosure may be implemented. FIGS. 5A-5E and 6 illustrate example workflows and/or computer-implemented methods for the different operational engines that may be implemented.

FIG. 1 depicts an example computing system 100 in which various embodiments of the present disclosure may be implemented. Depending on the embodiment, the example computing device 102 may include one or more processors 104, a network interface controller 105, and one or more memories 150. The memory 150 generally contains instructions including applications 110, a situational awareness engine 115, a treatment awareness engine 120, a documentation engine 125, a record management engine 130, a local record 135, and application data 140.

The computing device 102 may be connected to a network 108 that interfaces with sensors 151, 152, 154, 156 placed in strategic locations to better collect data related to a specific event. Each of the sensors 151-156 are generally configured to collect data relevant to a patient and patient environment and can be implemented as wearables or patches, traditional medical devices, stand-alone devices, vitals sensors and/or any other suitable implementation. As illustrated, the sensors 151-156 may include any number of sensors as needed to collect the appropriate data for the operation of the above engines or applications, such that n may be any integer value. Alternatively, the sensors 151-156 can interface directly with the computing device 102 instead of going through a network, especially in situations where a network (e.g., network 108) may not be available or network uptime is a concern, e.g., in ad hoc patient environments. For example, a sensor for any measurable quantity can be integrated into the system, such as, but not limited to, an ambient light sensor, a heart rate sensor, a blood pressure sensor, an audio sensor, a motion sensor, a pressure sensor, a breathing rate sensor, a dispensing apparatus sensor, an odor sensor, a proximity sensor, and/or any other suitable sensor(s) or combinations thereof.

An external server 106 may be connected to the network 108, and the server 106 may include at least a processor 106a, a memory 106b that stores a data set 106b1, and a networking interface 106c. In certain embodiments, the external server 106 can store patient records in a data set 106b1, which may act as a centralized record storage for patient data and records, treatment procedures, facility protocols, and the like. The computing device 102 can retrieve a patient record from the external server 106 when a patient is first brought into the environment that is managed by the computing device 102 so that practitioners have the most up-to-date record at the beginning of the patient's stay. The computing device 102 may also periodically and/or otherwise update the external server 106, such as during or after an event, with patient data received from practitioner input to the computing device 102 or sensor measurement data. In this manner, and as described herein, the external server 106 may receive event data updates from the computing device 102 while at least a portion of the event data may be cached in the local record 135 for greater data redundancy/reliability. It should be appreciated that the external server 106 can include one or multiple computing devices that are co-located or distributed.

The situational awareness engine 115 can analyze data corresponding to an entity (e.g., a patient) that is stored in the centralized record. In particular, the situational awareness engine 115 analyzes data to determine one or more threshold values for measurements that are sensed by the sensors 151-156. The situational awareness engine 115 then determines if at least one measurement fails to satisfy a relevant threshold, which generally indicates an event. An event generally indicates a change in the patient environment, patient physical condition, or relates to an action taken by a patient or practitioner, such as a sudden increase in heart rate or a motion sensor sensing the patient moving around the room.

If the computing device 102 determines an event is indicated, then an alert can be sent to a relevant caretaker. For example, in a healthcare context, the situational awareness engine 115 may receive a measurement from a light sensor indicating that the lights have been turned on in a patient room. In this example, the situational awareness engine 115 may simultaneously know that no one has entered the patient room because a door sensor has not sensed any movement. Thus, the situational awareness engine 115 may determine that the patient is out of bed and moving around the room, and the engine 115 may then transmit a notification to the caretaker so they can take proper action. In addition, the situational awareness engine 115 can determine the relative importance of a threshold and only alert a practitioner when a certain number of thresholds have been crossed. For example, a motion sensor may detect movement, which could indicate that a practitioner is in the room providing care. But if a door sensor has not detected that a door has opened, then the situational awareness engine 115 can determine that a patient is moving about the room and alert a practitioner.

The treatment awareness engine 120 is generally configured to determine appropriate treatments based on measurement data and determine if further entities require a notification of those treatments. To that end, the treatment awareness engine 120 is configured to use the measurement data to determine a treatment that is based on the event, determine one or more second entities to receive a notification based on the event and the treatment, and generate the notification based on the event, treatment, and/or the one or more second entities. This engine 120 allows for more than one entity to receive notifications of important data or events that occur for a patient, which is important if more than one practitioner is treating or monitoring a patient. For example, if a heart rate sensor detects an elevated heart rate, the treatment awareness engine 120 can determine that a practitioner associated with a cardiovascular specialty be alerted because the patient has a known cardiac issue that will require specialty attention. The treatment awareness engine 120 facilitates this specific notification without a primary practitioner being alerted and/or otherwise involved, which can result in the patient being treated sooner than if other practitioners are required to alert the specialty practitioner.

The automated documentation engine 125 is generally configured to automatically generate appropriate documents related to an event using the available data. More specifically, the automated documentation engine 125 periodically evaluates one or more subsequent measurements to enrich created documents with additional data, thereby allowing practitioners to access documents with up-to-date measurements leading to more well-informed care decisions. The automated documentation engine 125 can further determine that the event has concluded and then upload the document to the centralized record (e.g., data set 106b1) and cache the document in the local record 135. As previously mentioned, this creates data redundancy and ensures that the most up-to-date information for an event is always available locally where it is most likely to be needed. To perform the document generation/population, the automated documentation engine 125 retrieves a template document, tracks the relevant data required for the document (e.g., as measured by the sensors 151-156), and automatically generates/populates the document at the appropriate time, such as the end of an event. This engine 125 can be initiated by voice activation or manual interaction with the computing device 102, such as using a mouse and touchscreen.

The record continuity engine 130 is generally configured to determine which event data should be stored in the centralized record and/or the local record 135. The record continuity engine 130 determines the most relevant event data for a patient for a specified time period, updates the centralized record (e.g., data set 106b1), and caches at least a portion of the relevant event data in the local record 135. The record continuity engine 130 determines the most relevant event data based on any criteria, such as a criteria determined by a practitioner, an ML algorithm, a threshold based on measurement data detected by a sensor, and/or any other criteria. For example, the record continuity engine 130 may determine that data related to a patients'heart rate should be stored in the centralized record because the patient is in the cardiac care unit, and the engine 130 may then store and/or cause the heart rate data to be stored in both the centralized record and the local record 135.

The record continuity engine 130 improves data reliability relative to conventional systems. For example, if the electronic health record (EHR) system (e.g., centralized record) is inaccessible, regardless of the reason for the outage, the record continuity engine 130 ensures that the relevant event data is still accessible for practitioner use. Medical practitioners can therefore download documents with and/or otherwise access basic patient information that has been updated with the most recent measurement data and/or events despite not having access to the EHR. Thus, particularly in the case of an EHR failure, the record continuity engine 130 ensures that medical practitioners always have a portion of a patient's medical record available to make informed treatment decisions in view of relevant data about the patient, such as allergies, conditions, medications including last timing and dosage, and other event data. Further, in the event of a prolonged EHR failure/outage (e.g., hours, days, etc.), the record continuity engine 130 maintains accurate and reliable data in the local record 135 to ensure continued, proper medical care. The record continuity engine 130 can also operate in tandem/conjunction with the automated documentation engine 125 to create accurate, up-to-date medical records that contain the relevant information needed for practitioners to have needed information for patient treatment.

In some embodiments, the engines 115, 120, 125, 130 described herein may be machine learning (ML) models configured to employ ML algorithms that are trained and/or otherwise configured to perform the various functions described herein related to each engine 115, 120, 125, 130. Thus, one or more of the engines 115, 120, 125, 130 described herein may employ supervised learning, which involves identifying patterns in existing data to make predictions about subsequently received data. Specifically, the ML models may be “trained” using training data, which includes example inputs and associated example outputs. Based upon the training data, the ML models generate a predictive function which maps outputs to inputs and utilize the predictive function to generate ML outputs based upon data inputs. The example inputs and example outputs of the training data may include any of the data inputs or ML outputs described above. In the exemplary embodiment, a processing element may be trained by providing it with a large sample of data with known characteristics or features.

In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning.

In another embodiment, a machine learning program may employ unsupervised learning, which involves finding meaningful relationships in unorganized data. Unlike supervised learning, unsupervised learning does not involve user-initiated training based upon example inputs with associated outputs. Rather, in unsupervised learning, the machine learning model may organize unlabeled data according to a relationship determined by at least one machine learning method/algorithm employed by the machine learning model. Unorganized data may include any combination of data inputs and/or machine learning outputs as described above.

In yet another embodiment, a machine learning program may employ reinforcement learning, which involves optimizing outputs based upon feedback from a reward signal. Specifically, the machine learning programs may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

As an example, a machine learning program may employ natural language processing (NLP) functions, which generally involves understanding verbal/written communications and generating responses to such communications. The machine learning program may be trained to perform such NLP functionality using a symbolic method, machine learning models, and/or any other suitable training method. As an example, the machine learning program may be trained to perform at least two techniques that may enable the machine learning program to understand words spoken/written by a user: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (PoS) tagging, parsing, lemmatization and stemming, stop-word removal, and/or any other suitable sub-task or combinations thereof. For example, using syntactic analysis, the machine learning program may generate textual transcriptions from verbal responses from a user in a data stream.

Semantic analysis generally involves analyzing text in order to understand and/or otherwise capture the meaning of the text. In particular, the machine learning chatbot 104b2 applying semantic analysis may study the meaning of each individual word contained in a textual transcription in a process known as lexical semantics. Using these individual meanings, the machine learning program may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the machine learning program may generate one or more intent interpretations based upon one or more textual transcriptions from a syntactic analysis.

After training, machine learning programs (or information generated by such machine learning programs) may be used to evaluate additional data. Such data may be and/or may be related to measurement sensor data, medical history data, patient data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset. Such trained machine learning programs may, therefore, be used to perform part or all of the analytical functions of the methods described elsewhere herein.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, any of the machine learning programs/algorithms/models described herein may be used to output a diagnosis, an event indication, a document, audio or video, a response to a user or practitioner query, and/or any other values, responses, or combinations thereof using artificial intelligence (e.g., a machine learning model of the machine learning program) or, in alternative aspects, without using artificial intelligence.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

The local record 135 is a patient/event data repository implemented in the memory 150 that is used to store relevant data and treatments, such as sensor measurement data, event occurrences, current patient treatments, documentation, patient data, location history, and/or any other relevant information. The local record 135 may be partitioned and/or otherwise defined/instantiated for a single patient or patient room, such that data corresponding to a single patient and/or a limited number of patients may be stored in the local record 135. Further, the local record 135 can be set to store data for a specific length of time, such as keeping local records for the past hour, day, or any suitable user-defined time frame. For example, the local record 135 may contain the location history of the computing device 102, such as if a patient was initially in the emergency room but is now in the cardiac care unit or if a patient was in a temporary treatment facility before being moved to a permanent room.

The application 110 is computer readable code that causes the computing device 102 to access and execute the various engines 115-130 to perform the various functions described herein. The application may execute more than one engine 115-130 at a time to provide the appropriate function as needed for the situation, such as the automated documentation engine 125 and the record management engine 130. Further, the application 110 may include instructions that cause the processors 104 to transmit/store data into the centralized record (e.g., external server 106) and/or cache data into the local record 135, in accordance with determinations output by any of the engines 115-130 and/or otherwise output as part of the various functions described herein.

The application data 140 can include any data required for operating the system or that is necessary for any of the engines 115-130 to function. Generally, the application data 140 may include outputs of the application 110, such as outputs of the engines 115, 120, 125, 130 accessed/executed by the application 110. For example, the application data 140 may include documents related to a patient health history, treatment determinations, event indications, threshold values, notifications, patient health history data, patient physical characteristics, and/or other data.

More generally, it should be appreciated that, while the various components of the example computing system 100 (e.g., the processor 104, the computing device 102, the external server 106, etc.) are illustrated in FIG. 1 as single components, the example computing system 100 may include multiple (e.g., dozens, hundreds, thousands) of computing devices 102 and external servers 106 that are simultaneously connected to the network 108 at any given time.

The processors 104 and 106a may include any suitable number of processors and/or processor types. For example, the processors 104 and 160a may each include one or more CPUs and one or more graphics processing units (GPUs). Generally, each of the processors 104 and 106a may be configured to execute software instructions stored in the corresponding memories 150 and 106b. The memories 150 and 106b may include one or more persistent memories (e.g., a hard drive and/or solid-state memory) and may store one or more applications, modules, and/or models, such as the application 110, the engines 115, 120, 125, 130, and/or the application data 140.

and as illustrated in FIG. 1, the computing device 102 is communicatively coupled to the sensors 151-156 and/or the external server 106. For example, the computing device 102, the sensors 151-156, and/or the external server 106 may communicate via USB, Bluetooth, Wi-Fi Direct, Near Field Communication (NFC), etc. For example, the computing device 102, may transmit event data, documents, alerts, and/or any other values, responses, or combinations thereof to the external server 106 via the network interface controller 105, which the external server 106 may receive via the networking interface 106c.

The network interface controller 105 may enable the computing device 102 to communicate with the sensors 151-156, the external server 106, and/or any other suitable devices or combinations thereof. More specifically, the network interface controller 105 enables the computing device 102 to communicate with each component of the example computing system 100 across the network 108 through their respective networking interfaces (e.g., 106c). The network interface controller 105 and the networking interface 106c may support wired or wireless communications, such as USB, Bluetooth, Wi-Fi Direct, Near Field Communication (NFC), etc. The network interface controller 105 may enable the computing device 102 to communicate with the various components of the example computing system 100 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

Moreover, the network 108 may be a single communication network, or may include multiple communication networks of one or more types (e.g., one or more wired and/or PANs or LANs, and/or one or more WANs such as the Internet). In some embodiments, the network 108 includes multiple, entirely distinct networks (e.g., one or more networks for communications between the computing device 102 and the external server 106, and a separate, Bluetooth or wireless LAN (WLAN) network for communications between the computing device 102 and the sensors 151-156, and so on).

It will be understood that the above disclosure is one example and does not necessarily describe every possible embodiment. As such, it will be further understood that alternate embodiments may include fewer, alternate, and/or additional steps or elements.

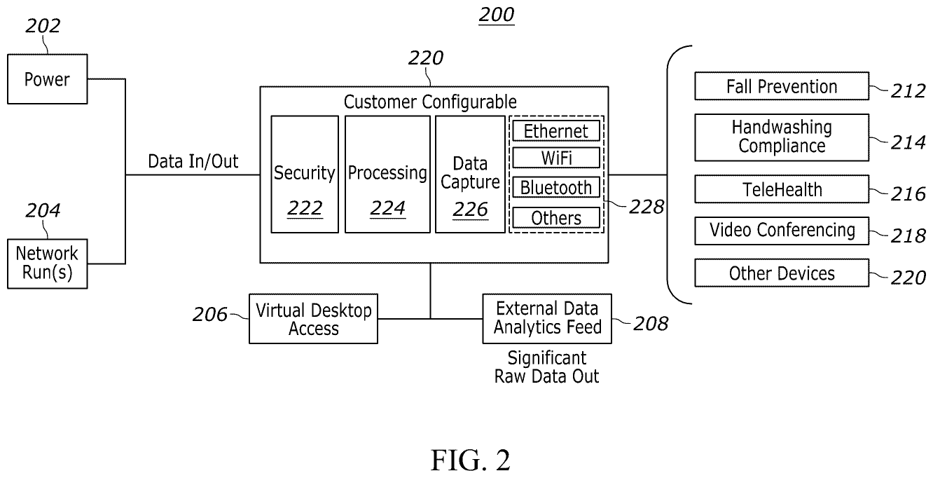

FIG. 2 illustrates a high-level example computing system 200 configured to perform various functions of, for example, the example computing system 100 of FIG. 1. Power supply 202 and network runs 204 generally provide power and hard-wired network connectivity, respectively, to the computing device 220 that includes modules for security 222, processing 224, data capture 226, and connectivity 228. Each of the connectivity modules 228 may provide access across a network, and may include Wi-Fi, cellular (3G, LTE, 5G), satellite, ethernet, wireless radio, and/or others.

The computing device 220 also includes virtual desktop access 206, so that the device 220 can operate as a normal workstation when needed. The external data analytics feed 208 is used to transfer raw data from the computing device 220 to an external server (e.g., external server 106) for further processing/analysis and/or storage. Each of the devices 212-218 may be measurement sensors that are connected to the computing device 220 using either a wireless or wired connection.

For example, the first device 212 may be for fall prevention, the second device 214 for handwashing compliance, the third device 216 for telehealth, and the fourth device 218 for video conferencing. Other devices can be installed in the computing system 200 related to any measurement data obtained from sensors or other useful modules. For example, the fall prevention devices may be an accelerometer, motion sensor, or other device that detects when a sudden movement occurs. This data is then used to determine if a falling event has occurred and if a practitioner should be notified. The handwashing compliance device 214 may be an audio sensor that detects the sounds of water running or a water sensor that detects the presence of water. This data is then used to determine if proper protocols are being followed by practitioners, patients, or visitors. The telehealth device 216 and video conferencing device 218 may be a networked audio/visual setup to allow for a practitioner to interact with a patient or for a patient to interact with friends and family members.

Various components of the example computing system 200 of FIG. 2 may be customizable by a user. For example, a user may customize and/or otherwise adjust aspects of one or more of the security module 222, the processing module 224 (e.g., including processing hardware or software), the data capture module 226, and/or the various connectivity modules 228. This flexible/modular configuration allows the example computing system 200 to be generally viable for any implementation or need in a patient setting, such as in an established hospital room, temporary patient treatment area, ambulance, and/or other treatment settings.

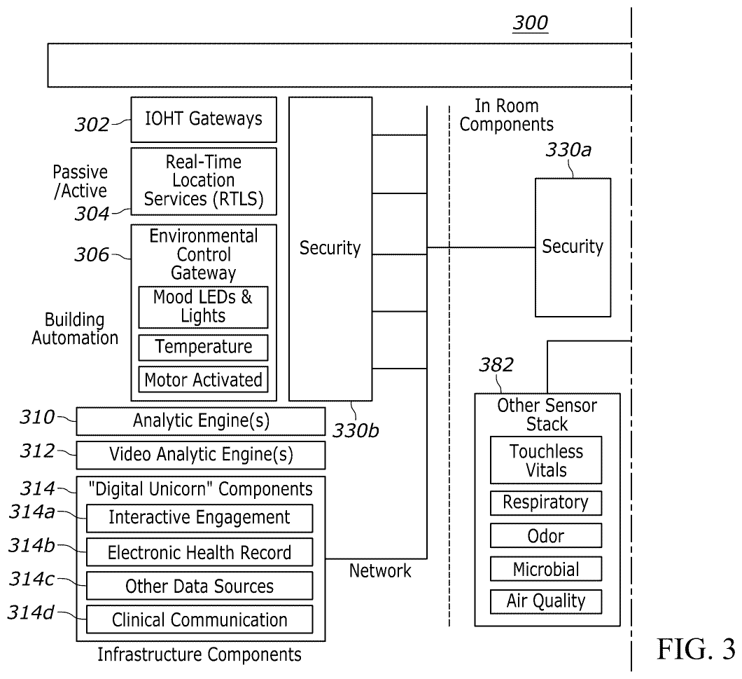

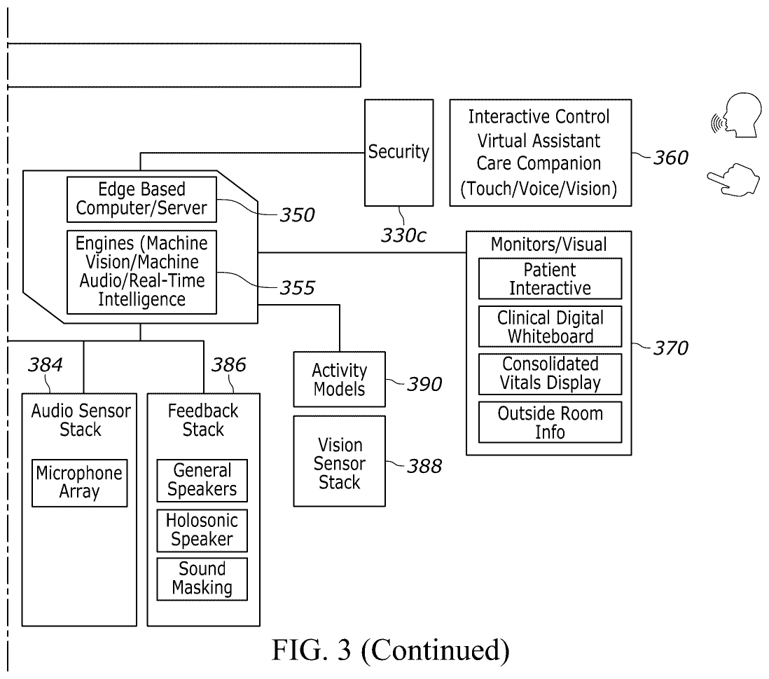

FIG. 3 depicts an example computer system 300 with various hardware and software components configured for operation. The computing system 350 can be an edge-based computer or server that includes the various engines 355 for monitoring patients and assisting practitioners, such as machine learning, machine vision, machine audio analysis, and/or real-time artificial intelligence analytics. In addition, the activity models 390 can be used as part of an ML or AI algorithm to assist the computing system 350 and various engines 355. The computing system 350 also includes a security module 330 configured to provide appropriate data and information security, such as via data encryption or hashing using any suitable encryption or hashing techniques or combinations thereof.

Several components connected to the computing system 350 include one or more Internet of Health Things (IoHT) gateways 302 for connected medical devices used to connect healthcare information technology; and real time location services 304 for tracking the location of the computing system 350, a patient, and/or other relevant objects. Further, these connected components include an environmental control gateway 306 that can control the environmental conditions in a patient setting, such as heating and cooling, lighting, and/or others, one or more analytic engine(s) 310, a video analytic engine(s) 312, and various digital systems 314. These digital systems 314 are generally components with a specialized purpose, such as interactive engagement components 314a, electronic health records 314b, other data sources 314c, and clinical communications 314d. These can all be connected to any available communication network and can be built into the patient setting as infrastructure components but need not be located/positioned directly in the patient setting (e.g., can be positioned remotely from the patient).

Further, FIG. 3 depicts example sensor stacks, including an audio sensor stack 384, a feedback stack 386, a vision sensor stack 388, and other sensor stacks 382. The other sensor stacks 382 may include, for example, sensors for obtaining touchless vitals, respiratory sensors, odor sensors, microbial sensors, air quality sensors, and/or other sensors. The vision sensor stack 388 may include RGB sensors, LIDAR, thermal sensors, and/or other vision related sensors. The audio sensor stack 384 may include a microphone or other audio sensing device. The feedback stack 386 may include speakers, sound masking, or other feedback mechanisms.

The computing system 350 may also include an interactive control virtual assistant 360 that can be voice, vision, or touch activated to provide care support functions, such as assistance in documentation or treatment. In addition, the interactive control virtual assistant 360 has an appropriate security layer integrated to ensure that information associated with the issue commands does not include, for example, identifiable information or otherwise secure data.

In addition, the computing system 350 may be connected to other environmental monitors 370, including patient interactive monitors where the patient can input information for communicating with practitioners, a clinical digital whiteboard for facilitating communication between practitioners and patients, a consolidated vitals display for displaying relevant vital measurements, and outside room information, such as weather, room location, or other information.

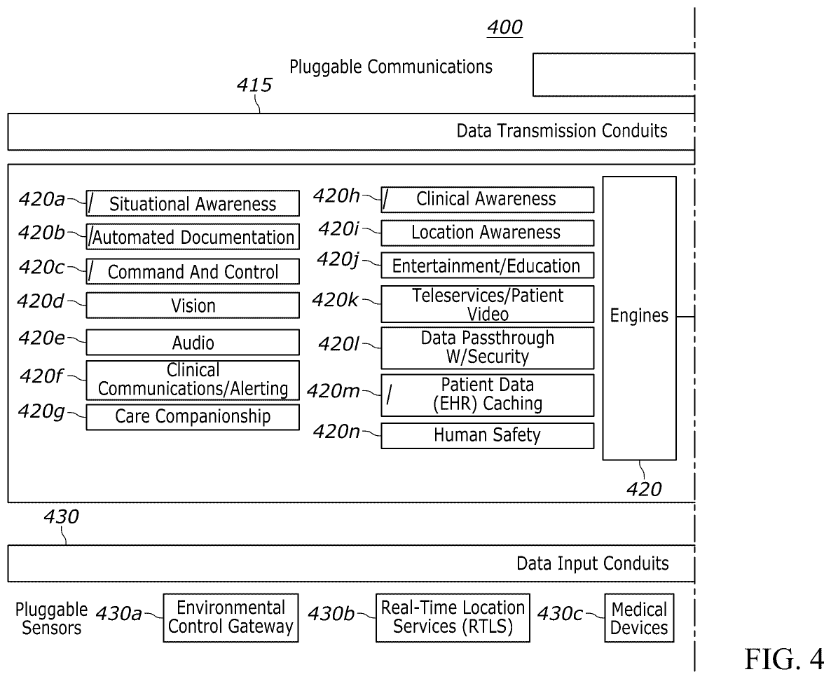

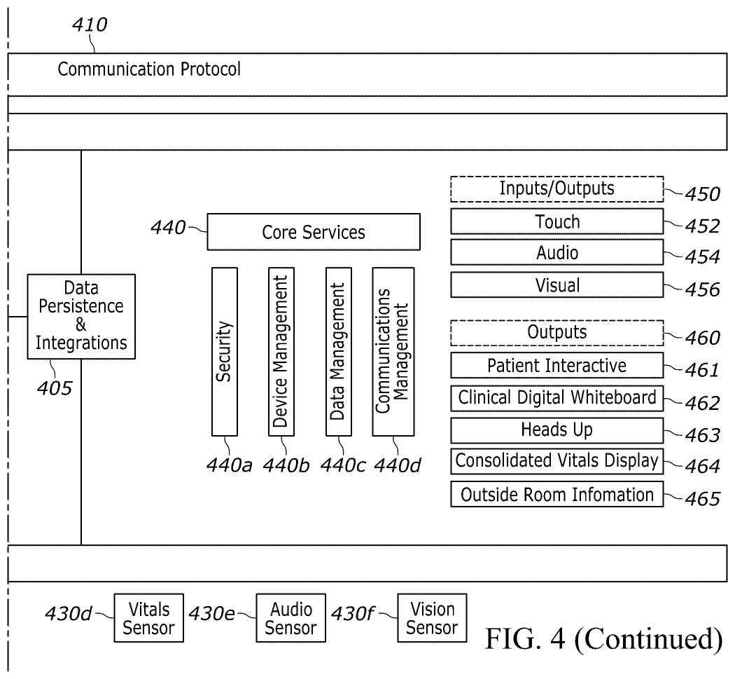

FIG. 4 depicts a block overview of an example computing system 400, including hardware and software implementations that may be used. The example computing system 400 may be and/or include portions of the example computing system 100 of FIG. 1.

The example computing system 400 includes a communication protocol block 410 can be implemented as any appropriate communication protocol, such as Wi-Fi, cellular (3G, LTE, 5G), satellite, ethernet, wireless radio, or others. The data transmission conduits 415 are generally configured to move data between the computing system 400 and external systems via the communication protocol block 410. The core services block 440 includes a security module 440a for protecting communications and data, a device management module 440b, a data management module 440c, and a communication management module 440d.

The example computing system 400 also includes examples of various engines 420 that can be integrated into the computer system 400. Namely, the various engines 420 include a situational awareness engine 420a, an automated documentation engine 420b, a command and control engine 420c, a vision engine 420d, an audio engine 420e, a clinical communications and alerting engine 420f, a care companionship engine 420g, a clinical awareness engine 420h, a location awareness engine 420i, an entertainment and education engine 420j, a teleservices and patient video engine 420k, a data passthrough with security engine 420l, a patient data (EHR) caching engine 420m, and a human safety engine 420n.

The vision engine 420d and audio engine 420e can be used alone or together to provide audio or visual interactions between a practitioner and patient or a patient and friends and family. They can also be used in conjunction with other engines to present relevant information, such as patient records, sensor data, treatment information, or other information. The clinical communications and alerting engine 420f can operate to provide clinical communications and alerts to medical practitioners and/or patients. The care companionship engine 420g can monitor visitors to a patient area, such as by medical staff or patient friends and family. The clinical awareness engine 420h generally operates similarly to the treatment awareness engine 120, as previously described. The location awareness engine 420i can use real-time location services to track the location of the computing device 102 or the patient. The entertainment and education engine 420j can work in conjunction with integrated audio and video to provide entertainment and educational information to the patient while they are near the computing device 102. The teleservices and patient video engine 420k can provide telehealth services to a patient, as previously described. The data passthrough and security engine 420l ensures that patient and sensor data is securely transmitted, such as to the central record or from a sensor to the computing device 102. The patent (EHR) caching engine 420m caches patient data from an EHR to the computing device 102 to ensure that relevant patient data is locally available to practitioners as needed, and in certain instances, may be and/or operate similarly to the record management engine 130 of FIG. 1. The human safety engine 420n provides appropriate safety information to a patient, such as medication-or location-related safety information.

Additionally, FIG. 4 depicts data input conduits 430 that can include pluggable sensors, such as for an environmental control gateway 430a, a real-time location services module 430b, a medical devices module 430c, a vitals sensor 430d, an audio sensor 430e, a vision sensor 430f, and/or other data inputs. These can be connected using wireless or wired connections. The computing system can have various inputs 450, such as a touch input 452, an audio input 454, and/or a visual input 456, and outputs 460 such as a patient interactive interface 461, a clinical virtual whiteboard 462, a heads-up display 463, a consolidated vitals display 464, an outside room information display 465, and/or other inputs or outputs.

FIGS. 5A-E depict example workflows for the different operational engines that may be implemented, in accordance with various embodiments described herein. In FIG. 5A, a workflow 500 for the basic operation of a computing system described herein is shown. First, measurement data is collected from the measurement sensors and input to into the computing system. The measurement data is input into the computing system. The measurement data can be used in conjunction with other data, such as patient health record data and threshold values, to determine if an event occurred at block 510. If an event is determined to have occurred, a notification of that event is sent by the computing device 102 and the centralized record is updated at block 512. At block 514, the computing system determines that at least a portion of the event data should be cached locally for storage (e.g., within the local record 135).

For example, if a patient is admitted to a hospital, the computing system can monitor the patient's blood pressure. If there is a rapid change in blood pressure, the system can determine that an event has occurred by comparing the readings to a threshold set by the practitioner and/or by the situational awareness engine 115 and/or the record management engine 130, update the central record with the blood pressure readings, and then cache the data locally for use by a practitioner.

In FIG. 5B, the operation of the situational awareness engine (e.g., engine 115) is demonstrated. At block 505, sensor measurement data is input, which is input to the situational awareness engine and used by the engine to determine threshold values in block 520. At block 522, the engine compares the measurement data to the threshold values. At block 524, the engine determines whether the threshold is satisfied. If the threshold is satisfied, then the method returns to block 505 of monitoring sensor measurement data. If the threshold is not satisfied, at block 526 the engine generates an event indication, and at block 528 the engine transmits and/or causes a computing device to transmit a notification of the event. The system/engine then resumes monitoring sensor measurement data (e.g., at block 505).

Returning to the example above, when a patient is admitted to the hospital after complaining of chest pain, the computing system can monitor the patient's blood pressure, similar to the situation described in FIG. 5A. However, the situational awareness engine can determine the relevant threshold values for blood pressure using data obtained from previous heart rate monitoring, as well as other data sources, such as patient physical characteristics (e.g. height, weight, age, etc.) or patient historical data (e.g. previous blood pressure readings from prior visits, family history, etc.). The engine may then compare the measurement data to this more holistically-derived threshold to determine if the threshold is satisfied.

As discussed above, the situational awareness engine can be used to augment the computing system for greater contextual awareness of the patient, relevant data, etc. to provide clinical decision support for the practitioner. This can improve overall patient advocacy by combining relevant information for use in patient treatment.

FIG. 5C demonstrates the operation of the treatment awareness engine, working in conjunction with the methods illustrated in either of FIGS. 5A and/or 5B. Using the data from the central record or local cache or event notification from the situational awareness engine, at block 530 the treatment awareness engine determines a recommended treatment. At block 532, the engine determines whether one or more second entities should receive the event notification. If there are more entities that should receive the notification, the engine generates and transmits/causes a computing device to transmit the notification to the one or more second entities. The treatment awareness engine can thus alert specialist practitioners, such as a cardiologist, of an event or treatment that has occurred for a patient without needlessly involving additional practitioners to spend time making such notifications.

Using the previous example of a patient admitted with chest pain, the treatment awareness engine can determine a treatment, such as suggesting appropriate medication or further interventions. The treatment awareness engine can also determine that another practitioner should be alerted, such as a cardiology team member or internal medicine expert.

The situational awareness engine can then generate and send a notification to the cardiology team or internal medicine expert.

FIG. 5D demonstrates the operation of the automated documentation engine, working in conjunction with the methods illustrated in any of FIGS. 5A-5C. At block 542, the automated documentation engine determines a document to automatically generate/populate in response to an event. At block 544, the engine periodically evaluates the measurement data to determine if the data can be used to enrich the document, such as further heart rate or blood pressure measurements. At block 546, the engine determines if the event has concluded. If the engine determines that the event has not concluded/ended, the method returns to block 544 to continue evaluating the measurement data. If the engine determines that the event has concluded, the engine merges any new monitored data into the document at block 548 and uploads the document to the centralized record, if available, in block 550. At block 552, the document is cached in the local record.

Again returning to the example of a patient with chest pain and building from the situational awareness engine, the documentation engine can determine that a document related to the patient's chest pain is appropriate and create such a document. The document may have fields or information related to time of symptoms, severity, any administered treatments, current status of relevant vitals, or other appropriate data. The documentation engine can update the document using continuing blood pressure data to keep the document up to date. If a practitioner visits the patient and determines that the patient is healthy or no longer at risk of a significant cardiac event, the documentation engine can determine that the event has concluded, upload the document to the centralized record, and cache the document in the local record. As previously mentioned, the local caching is useful because if the patient experiences another symptom or episode of chest pain, the document can be quickly retrieved for review by a practitioner.

FIG. 5E demonstrates the operation of the record continuity engine, working in conjunction with the methods illustrated in any of FIGS. 5A-5D. At block 560, the engine determines the event data to be stored in the centralized record. This determination can be based on any number of factors, such as the relevance to the most recent event as defined by a practitioner, a threshold, or a machine learning algorithm. At block 562, the engine determines the portion of the event data to be cached in the local record. This can be a subset of the available data related to the event or all data collected in a certain time frame, such as from when an even was determined to occur or a certain time frame before the event occurred. At block 564, the engine updates the centralized record with the event data. At block 566, the engine caches at least a portion of the event data in the local record.

As discussed herein, it should be understood that any/all of the engines described herein can be implemented using an automated algorithm, such as machine learning, where the training data can be obtained using anonymized data from previous patients.

FIG. 6 depicts an example computer-implemented method 600 that may be implemented, in accordance with various embodiments described herein. It should be appreciated that the actions illustrated in FIG. 6 may utilize and/or otherwise be performed by various components described herein, such as the computing device 102 of FIG. 1.

At block 602, the method 600 includes accessing (i) a centralized record including data corresponding to an entity and (ii) one or more sensors configured to sense one or more phenomena associated with the entity. At block 604, the method 600 includes receiving a set of measurements of the one or more phenomena sensed by the one or more sensors. At block 606, method 600 includes determining an event corresponding to the entity based on the set of measurements. At block 608, method 600 includes updating the centralized record with event data associated with the event. At block 610, method 600 includes caching at least a portion of the event in the local record. Optionally, the method 600 may further include analyzing the data corresponding to the entity that is stored in the centralized record to determine one or more threshold values (block 612). At optional block 614, the method 600 includes comparing the set of measurements with the one or more threshold values. At optional block 616, the method 600 includes determining that at least one measurement in the set of measurements fails to satisfy at least one threshold value of the one or more threshold values, wherein failing to satisfy the at least one threshold value indicates the event.

In some aspects, the situational awareness engine includes a machine learning (ML) model trained to receive training sensor measurements and training entity data as inputs to output training events.

In some aspects, the entity is a first entity, and the method 600 further includes transmitting a notification to one or more second entities indicating the event.

In some aspects, the method 600 further includes executing a treatment awareness engine to determine a treatment based on the event; determine the one or more second entities to receive the notification based on (i) the event and (ii) the treatment; and generate the notification based on (i) the event, (ii) the treatment, and (iii) the one or more second entities.

In some aspects, the method 600 further includes responsive to determining that the event has initiated, executing an automated documentation engine to (i) determine a document to be at least partially completed in response to the event, and (ii) initiate creation of the document to indicate one or more measurements from the set of measurements; periodically evaluating one or more subsequent measurements received from the one or more sensors during the event to enrich, by the automated documentation engine, the document with at least one measurement of the one or more subsequent measurements; and responsive to determining that the event has concluded, (i) uploading the document to the centralized record, and (ii) caching the document in the local record.

In some aspects, the automated documentation engine includes a ML model trained to receive training sensor measurements and training events as inputs to output training documents.

In some aspects, the method 600 further includes executing a record continuity management engine to determine (i) the event data to be stored in the centralized record and (ii) at least the portion of the event data to be cached in the local record based on one or more measurements from the set of measurements causing the event; update the centralized record with the event data associated with the event; and cache at least the portion of the event data in the local record.

In some aspects, the record continuity management engine includes a ML model trained to receive training sensor measurements and training events as inputs to output training record updates.

In some aspects, the one or more sensors include (i) a heart rate sensor, (ii) a blood pressure sensor, (iii) an ambient light sensor, (iv) an audio sensor, (v) a motion sensor, (vi) a pressure sensor, (vii) a breathing rate sensor, or (viii) a dispensing apparatus sensor.

In some aspects, the method 600 further includes periodically uploading portions of the local record to a cloud-based record that is different from the centralized record.

### EXAMPLES

Example 1. A device for improving data reliability, the device comprising: a networking interface providing access to (i) a centralized record including data corresponding to an entity and (ii) one or more sensors configured to sense one or more phenomena associated with the entity; one or more processors; and one or more memories communicatively coupled with the networking interface, the one or more sensors, and the one or more processors, storing (i) a local record of cached data that is different from the centralized record and (ii) computer-executable instructions thereon that, when executed by the one or more processors, cause the device to: receive, via the networking interface, a set of measurements of the one or more phenomena sensed by the one or more sensors, determine an event corresponding to the entity based on the set of measurements, update the centralized record with event data associated with the event, and cache at least a portion of the event data in the local record.

Example 2. The device of example 1, wherein the one or more memories further store a situational awareness engine, and wherein the computer-executable instructions, when executed by the one or more processors, cause the device to execute the situational awareness engine to: analyze the data corresponding to the entity that is stored in the centralized record to determine one or more threshold values; compare the set of measurements with the one or more threshold values; and determine that at least one measurement in the set of measurements fails to satisfy at least one threshold value of the one or more threshold values, wherein failing to satisfy the at least one threshold value indicates the event.

Example 3. The device of any of examples 1 or 2, wherein the situational awareness engine includes a machine learning (ML) model trained to receive training sensor measurements and training entity data as inputs to output training events.

Example 4. The device of any of examples 1 through 3, wherein the entity is a first entity, and wherein the computer-executable instructions, when executed by the one or more processors, further cause the device to: transmit a notification to one or more second entities indicating the event.

Example 5. The device of example 4, wherein the one or more memories further store a treatment awareness engine, and the computer-executable instructions, when executed by the one or more processors, further cause the device to execute the treatment awareness engine to: determine a treatment based on the event; determine the one or more second entities to receive the notification based on (i) the event and (ii) the treatment; and generate the notification based on (i) the event, (ii) the treatment, and (iii) the one or more second entities.

Example 6. The device of any of examples 1 through 5, wherein the computer-executable instructions, when executed by the one or more processors, further cause the device to: responsive to determining that the event has initiated, execute an automated documentation engine to (i) determine a document to be at least partially completed in response to the event, and (ii) initiate creation of the document to indicate one or more measurements from the set of measurements; periodically evaluate one or more subsequent measurements received from the one or more sensors during the event to enrich, by the automated documentation engine, the document with at least one measurement of the one or more subsequent measurements; and responsive to determining that the event has concluded, (i) uploading the document to the centralized record, and (ii) caching the document in the local record.

Example 7. The device of example 6, wherein the automated documentation engine includes a ML model trained to receive training sensor measurements and training events as inputs to output training documents.

Example 8. The device of any of examples 1 through 7, wherein the one or more memories further store a record continuity management engine, and wherein the computer-executable instructions, when executed by the one or more processors, cause the device to execute the record continuity management engine to: determine (i) the event data to be stored in the centralized record and (ii) at least the portion of the event data to be cached in the local record based on one or more measurements from the set of measurements causing the event; update the centralized record with the event data associated with the event; and cache at least the portion of the event data in the local record.

Example 9. The device of example 8, wherein the record continuity management engine includes a ML model trained to receive training sensor measurements and training events as inputs to output training record updates.

Example 10. The device of any of examples 1 through 9, wherein the one or more sensors include (i) a heart rate sensor, (ii) a blood pressure sensor, (iii) an ambient light sensor, (iv) an audio sensor, (v) a motion sensor, (vi) a pressure sensor, (vii) a breathing rate sensor, or (viii) a dispensing apparatus sensor.

Example 11. The device of any of examples 1 through 10, wherein the computer-executable instructions, when executed by the one or more processors, cause the device to: periodically upload portions of the local record to a cloud-based record that is different from the centralized record.

Example 12. A method for improving data reliability, the method comprising: receiving, at one or more processors via a networking interface, a set of measurements of one or more phenomena experienced by an entity and sensed by one or more sensors; determining, by the one or more processors, an event corresponding to the entity based on the set of measurements; updating, by the one or more processors, a centralized record with event data associated with the event; and caching, by the one or more processors, at least a portion of the event data in a local record that is different from the centralized record.

Example 13. The method of example 12, the method further comprising: executing, by the one or more processors, a situational awareness engine to: analyze the data corresponding to the entity that is stored in the centralized record to determine one or more threshold values, compare the set of measurements with the one or more threshold values, and determine that at least one measurement in the set of measurements fails to satisfy at least one threshold value of the one or more threshold values, wherein failing to satisfy the at least one threshold value indicates the event.

Example 14. The method of example 13, wherein the situational awareness engine includes a machine learning (ML) model trained to receive training sensor measurements and training entity data as inputs to output training events.

Example 15. The method of any of examples 12 through 14, further comprising: responsive to determining that the event has initiated, executing, by the one or more processors, an automated documentation engine to (i) determine a document to be completed in response to the event, and (ii) initiate creation of the document to indicate one or more measurements from the set of measurements; periodically evaluating, by the one or more processors, one or more subsequent measurements received from the one or more sensors during the event to enrich, by the automated documentation engine, the document with at least one measurement of the one or more subsequent measurements; and responsive to determining that the event has concluded: uploading, by the one or more processors, the document to the centralized record, and caching, by the one or more processors, the document in the local record.

Example 16. The method of any of examples 12 through 15, further comprising: transmitting, by the one or more processors via the networking interface, a notification to one or more second entities indicating the event; determining, by the one or more processors, a treatment based on the event; determining, by the one or more processors, the one or more second entities to receive the notification based on (i) the event and (ii) the treatment; and generating, by the one or more processors, the notification based on (i) the event, (ii) the treatment, and (iii) the one or more second entities.

Example 17. The method of any of examples 12 through 16, further comprising: determining, by the one or more processors, (i) the event data to be stored in the centralized record and (ii) at least the portion of the event data to be cached in the local record based on one or more measurements from the set of measurements causing the event; updating, by the one or more processors, the centralized record with the event data associated with the event; and caching, by the one or more processors, at least the portion of the event data in the local record.

Example 18. The method of example 17, wherein determining the event data and the at least the portion of the event data is performed using a ML model, and the ML model is trained to receive training sensor measurements and training events as inputs to output training record updates.

Example 19. The method of any of examples 12 through 18, further comprising: periodically uploading, by the one or more processors, portions of the local record to a cloud-based record that is different from the centralized record.

Example 20. A computer-readable medium storing instructions that, when executed by a computer, cause the computer to: receive a set of measurements of one or more phenomena experienced by an entity and sensed by one or more sensors; determine an event corresponding to the entity based on the set of measurements; update a centralized record with event data associated with the event; and cache at least a portion of the event data in a local record that is different from the centralized record.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . .” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S. C. § 112(f) unless traditional means-plus-function language is expressly recited, such as “means for” or “step for” language being explicitly recited in the claim(s).

What is claimed is:

1. A device for improving data reliability, the device comprising:
a networking interface providing access to (i) a centralized record including data corresponding to an entity and (ii) one or more sensors configured to sense one or more phenomena associated with the entity;
one or more processors; and
one or more memories communicatively coupled with the networking interface, the one or more sensors, and the one or more processors, storing (i) a local record of cached data that is different from the centralized record and (ii) computer-executable instructions thereon that, when executed by the one or more processors, cause the device to:
receive, via the networking interface, a set of measurements of the one or more phenomena sensed by the one or more sensors,
determine an event corresponding to the entity based on the set of measurements,
update the centralized record with event data associated with the event, and
cache at least a portion of the event data in the local record.

2. The device of claim 1, wherein the one or more memories further store a situational awareness engine, and wherein the computer-executable instructions, when executed by the one or more processors, cause the device to execute the situational awareness engine to:
analyze the data corresponding to the entity that is stored in the centralized record to determine one or more threshold values;
compare the set of measurements with the one or more threshold values; and
determine that at least one measurement in the set of measurements fails to satisfy at least one threshold value of the one or more threshold values, wherein failing to satisfy the at least one threshold value indicates the event.

3. The device of claim 2, wherein the situational awareness engine includes a machine learning (ML) model trained to receive training sensor measurements and training entity data as inputs to output training events.

4. The device of claim 1, wherein the entity is a first entity, and wherein the computer-executable instructions, when executed by the one or more processors, further cause the device to:
transmit a notification to one or more second entities indicating the event.

5. The device of claim 4, wherein the one or more memories further store a treatment awareness engine, and the computer-executable instructions, when executed by the one or more processors, further cause the device to execute the treatment awareness engine to:
determine a treatment based on the event;
determine the one or more second entities to receive the notification based on (i) the event and (ii) the treatment; and
generate the notification based on (i) the event, (ii) the treatment, and (iii) the one or more second entities.

6. The device of claim 1, wherein the computer-executable instructions, when executed by the one or more processors, further cause the device to:
responsive to determining that the event has initiated, execute an automated documentation engine to (i) determine a document to be at least partially completed in response to the event, and (ii) initiate creation of the document to indicate one or more measurements from the set of measurements;
periodically evaluate one or more subsequent measurements received from the one or more sensors during the event to enrich, by the automated documentation engine, the document with at least one measurement of the one or more subsequent measurements; and
responsive to determining that the event has concluded, (i) uploading the document to the centralized record, and (ii) caching the document in the local record.

7. The device of claim 6, wherein the automated documentation engine includes a ML model trained to receive training sensor measurements and training events as inputs to output training documents.

8. The device of claim 1, wherein the one or more memories further store a record continuity management engine, and wherein the computer-executable instructions, when executed by the one or more processors, cause the device to execute the record continuity management engine to:
determine (i) the event data to be stored in the centralized record and (ii) at least the portion of the event data to be cached in the local record based on one or more measurements from the set of measurements causing the event;
update the centralized record with the event data associated with the event; and
cache at least the portion of the event data in the local record.

9. The device of claim 8, wherein the record continuity management engine includes a ML model trained to receive training sensor measurements and training events as inputs to output training record updates.

10. The device of claim 1, wherein the one or more sensors include (i) a heart rate sensor, (ii) a blood pressure sensor, (iii) an ambient light sensor, (iv) an audio sensor, (v) a motion sensor, (vi) a pressure sensor, (vii) a breathing rate sensor, or (viii) a dispensing apparatus sensor.

11. The device of claim 1, wherein the computer-executable instructions, when executed by the one or more processors, cause the device to:
periodically upload portions of the local record to a cloud-based record that is different from the centralized record.

12. A method for improving data reliability, the method comprising:
receiving, at one or more processors via a networking interface, a set of measurements of one or more phenomena experienced by an entity and sensed by one or more sensors;
determining, by the one or more processors, an event corresponding to the entity based on the set of measurements;
updating, by the one or more processors, a centralized record with event data associated with the event; and
caching, by the one or more processors, at least a portion of the event data in a local record that is different from the centralized record.

13. The method of claim 12, the method further comprising:
executing, by the one or more processors, a situational awareness engine to:
analyze the event data corresponding to the entity that is stored in the centralized record to determine one or more threshold values,
compare the set of measurements with the one or more threshold values, and
determine that at least one measurement in the set of measurements fails to satisfy at least one threshold value of the one or more threshold values, wherein failing to satisfy the at least one threshold value indicates the event.

14. The method of claim 13, wherein the situational awareness engine includes a machine learning (ML) model trained to receive training sensor measurements and training entity data as inputs to output training events.

15. The method of claim 12, further comprising:
responsive to determining that the event has initiated, executing, by the one or more processors, an automated documentation engine to (i) determine a document to be completed in response to the event, and (ii) initiate creation of the document to indicate one or more measurements from the set of measurements;
periodically evaluating, by the one or more processors, one or more subsequent measurements received from the one or more sensors during the event to enrich, by the automated documentation engine, the document with at least one measurement of the one or more subsequent measurements; and
responsive to determining that the event has concluded:
uploading, by the one or more processors, the document to the centralized record, and
caching, by the one or more processors, the document in the local record.

16. The method of claim 12, further comprising:
transmitting, by the one or more processors via the networking interface, a notification to one or more second entities indicating the event;
determining, by the one or more processors, a treatment based on the event;
determining, by the one or more processors, the one or more second entities to receive the notification based on (i) the event and (ii) the treatment; and
generating, by the one or more processors, the notification based on (i) the event, (ii) the treatment, and (iii) the one or more second entities.

17. The method of claim 12, further comprising:
determining, by the one or more processors, (i) the event data to be stored in the centralized record and (ii) at least the portion of the event data to be cached in the local record based on one or more measurements from the set of measurements causing the event;
updating, by the one or more processors, the centralized record with the event data associated with the event; and
caching, by the one or more processors, at least the portion of the event data in the local record.

18. The method of claim 17, wherein determining the event data and the at least the portion of the event data is performed using a ML model, and the ML model is trained to receive training sensor measurements and training events as inputs to output training record updates.

19. The method of claim 12, further comprising:
periodically uploading, by the one or more processors, portions of the local record to a cloud-based record that is different from the centralized record.

20. A computer-readable medium storing instructions that, when executed by a computer, cause the computer to:
receive a set of measurements of one or more phenomena experienced by an entity and sensed by one or more sensors;
determine an event corresponding to the entity based on the set of measurements;
update a centralized record with event data associated with the event; and
cache at least a portion of the event data in a local record that is different from the centralized record.
